(19) United States
(12) Patent Application Publication
(10) Pub. No.: US 2014/0150243 A1
(43) Pub. Date: Jun. 5, 2014

(54) WHEEL RECUTTING

(71) Applicant: Marek Mamczur, Hampshire (GB)

(72) Inventor: Marek Mamczur, Hampshire (GB)

(21) Appl. No.: 13/836,912

(22) Filed: Mar. 15, 2013

(30) Foreign Application Priority Data
Dec. 3, 2012 (GB) 1221742.8

(51) Int. Cl. B23B 5/28; B23B 1/00; B23B 25/06

(52) U.S. Cl. CPC B23B 5/28; B23B 25/06; B23B 1/00
USPC 29/527.4; 82/104; 82/1.11

(57) ABSTRACT

An apparatus for recutting the surface of a wheel is described. The apparatus comprises a rotatable mount, for holding and rotating the wheel about its axis, a surface profiler, configured to detect and output a surface elevation profile of a concentric ring at a current radial position on the surface of the wheel, a linear drive mechanism, configured to reposition the surface profiler radially with respect to the wheel, a radial profile generator, configured to calculate a cutting profile for the wheel based on the surface elevation profile for each concentric ring, a cutting tool, and cutting control circuitry, configured to control the position of the cutting tool with respect to the wheel to recut the surface of the wheel in accordance with the generated cutting profile.

### CROSS-REFERENCE TO RELATED APPLICATIONS

This application claims priority under 35 U.S.C. §119 to United Kingdom patent application serial no. 1221742.8, filed Dec. 3, 2012, the disclosure of which is incorporated herein by reference in its entirety.

### FIELD OF THE INVENTION

The present invention relates to wheel recutting.

### BACKGROUND OF THE INVENTION

Modern alloy vehicle wheels have become more prevalent with a finish commonly known as “diamond turned”. This finish involves mounting the wheel onto a lathe during manufacture and turning usually the front face of the wheel to leave a mirror like finish. This finish is then preserved by applying a transparent lacquer coating to the lathe-turned face rather than using a colored paint finish.

Unfortunately, after exposure to the environment, this lacquer may become damaged due for example to ultra violet sunlight or mechanical impact. This damage to the lacquer allows water and air to come into contact with the machined aluminum face, which in turn oxidizes (corrodes) and ruins the aesthetic appearance of the wheel.

It is possible to repair this damage by using a lathe and cutting tool to follow the radial profile of the wheel to remove the lacquer and top layer of oxidized alloy. This repair process is currently carried out using either a manual lathe and an operator to guide the cutting tool across the radial profile of the wheel (using X-Y slides) or from a semi-automated process that uses a touch (contact) probe to “map” a user selected radial profile and then to automatically follow the mapped profile with a cutting tool.

However, there are a number of drawbacks associated with these processes. For example, the manual method is time consuming and requires a skilled machinist to operate the lathe. Furthermore, in the manual method, if a misjudgment is made during the process of moving both the X & Y slides together, then the wheel may be irreparably damaged. The automated process using a touch probe relies on repeatedly moving a contact probe mounted on the lathe, up to the face of the wheel along an operator-selected-and-aligned wheel radial and mapping the point of contact with respect to the radial distance to obtain a wheel profile. It will be appreciated that this requires the wheel to be held stationary. It will further be appreciated that since the probe tool is aligned with the wheel radial, the process can fail if a double spoke style wheel is being probed. Still further, the physical size of the touch probe makes it difficult to obtain an accurate mapping of wheel profile particularly where there are profile changes which are similar in size to the physical dimensions of the touch probe.

Alternative systems and methods are desired.

### SUMMARY

According to a first aspect of the present invention, there is provided an apparatus for recutting the surface of a wheel, the apparatus comprising: a rotatable mount, for holding and rotating the wheel about its axis; a surface profiler, configured to detect and output a surface elevation profile of a concentric ring at a current radial position on the surface of the wheel; a linear drive mechanism, configured to reposition the surface profiler radially with respect to the wheel, a cutting profile generator, configured to calculate a cutting profile for the wheel based on the surface elevation profiles of at least some of the concentric rings; a cutting tool; and cutting control circuitry, configured to control the position of the cutting tool with respect to the wheel to recut the surface of the wheel in accordance with the generated cutting profile.

This process can be completely or substantially automated, with the operator optionally specifying a cutting depth (i.e. the amount of material to be cut away from the surface of the wheel). It will be appreciated that the cutting depth would be applied to the cutting profile generated by the cutting profile generator. In order to ensure that the entire surface of the wheel is recut, the cutting profile which is used should be based on appropriate data within the surface elevation profile of the wheel for each radius. The present invention can readily derive this information for any given radius from the corresponding surface elevation profile.

It will be appreciated that the cutting profile may be generated in respect of the complete top surface of the wheel using all of the surface elevation profiles, or may alternatively be generated in respect of a radial portion of the top surface of the wheel using a subset of the surface elevation profiles. Equally it will be appreciated that the apparatus may be configured to only generate surface elevation profiles for a radial portion of the top surface of the wheel where only that portion requires refinishing.

The cutting tool may be moveable both radially with respect to the wheel and parallel to the axis of rotation of the wheel. The cutting control circuitry is configured to control the position of the cutting tool and the rotation of the wheel to recut the surface of the wheel. The cutting tool and the surface profiler may be co-mounted, in which case the cutting control circuitry may be configured to control the axial position of the cutting tool using the linear drive mechanism (which is therefore used for both the profiling and cutting stages, thereby reducing the size of the apparatus).

A 3D map generator may also be provided, to generate and display to an operator a 3D representation of the surface of the wheel based on a set of surface elevation profiles of concentric rings at different radial positions. In this way, the whole wheel radial profile can be mapped though 360 degrees allowing the computer system to find buckles or other problems with wheel geometry which may affect vehicle safety or the subsequent cutting process, thus allowing the operator to correct a problem before a irreversible cut is made to the wheel.

The 3D map generator may itself be configured to automatically detect abnormalities in the surface of the wheel from the 3D representation, and to highlight any detected abnormalities to the operator. Pattern recognition techniques could be used. Wheels typically make use of repeating patterns of spokes, nuts and apertures, and therefore an isolated (i.e. non-repeating) occurrence of a shape can be assumed to relate to an abnormality, which could then be brought to the attention of the operator.

An angular encoder may be used to detect and output a current angular position of the wheel with respect to a reference position. This information can be used to generate the 3D representation.

While the surface profiler could in principle be a contact-based profiler, preferably the surface profiler is a non-contact profiler. More preferably the non-contact profiler is an optical profiler. Still more preferably the optical profiler is a laser.

The rotatable mount may be configured to rotate the wheel at a constant angular velocity for all radii. This arrangement is simple from a mechanical and control perspective, but results in a higher spatial sampling density towards the centre of the wheel than near the perimeter of the wheel. As a result, the constant angular velocity should be selected in dependence on the maximum radius for surface elevation measurement and the sampling rate of the surface profiler so that an acceptable spatial sampling density is achieved towards the outside of the wheel.

Alternatively, the rotatable mount may be configured to rotate the wheel at a variable angular velocity, the angular velocity being decreased incrementally as the linear drive mechanism increases the radial distance of the surface profiler from the centre of the wheel. In this way a substantially constant spatial sampling density can be achieved across the full surface of the wheel, but at the cost of increased mechanical and control complexity.

The surface of the wheel may include both relatively flat or slowly undulating portions, and also relatively sharp changes in elevation. To take account of this, the linear drive mechanism may be configured to incrementally reposition the surface profiler by a first radial distance following the completion of a surface elevation profile of each concentric ring, and to detect a high frequency change between the surface elevation profiles of adjacent concentric rings, and if such a change is detected, to incrementally reposition the surface profiler by a second radial distance smaller than the first radial distance at, near or around the radius at which the high frequency change was detected. In this way, the concentric rings sampled by the surface profiler may be spaced apart more in areas where there are no changes or only low frequency changes in the surface elation than in areas where high frequency changes occur.

In one way of implementing this, the surface profiler is configured to detect a high frequency change when the change in surface elevation on a radial line between a first surface elevation profile and a second surface elevation profile exceeds a first predetermined magnitude, to rewind the surface profiler position and incrementally reposition the surface profiler by the second radial distance from the radial position corresponding to the first surface elevation profile, and to continue to incrementally reposition the surface profiler by the second amount until a change in the surface elevation between adjacent surface elevation profiles falls below a second predetermined magnitude, whereupon the linear drive mechanism reverts to incrementally repositioning the surface profiler by the first amount.

Further benefits of embodiments of the invention include but are not limited to: an accurate radial profile can be extracted irrespective of the number and type of spokes; small radius curves can accurately be mapped since laser displacement spot size can be orders of magnitude smaller than a touch probe diameter; wheel digitization resolution is many orders of magnitude higher than using a touch probe due to laser displacement sensor spot size the repetition rate of the sensor (a laser displacement sensor can take thousands or even millions of samples per second compared with the ˜1 sample a second of a usual touch probe approach); the whole process from scan through to cutting can be completely automated requiring no skilled machinist or manual X-Y portions of the cutting process as with a touch probe approach when a small radius is encountered.

According to a another aspect of the present invention, there is provided a method of recutting the surface of a wheel, the method comprising the steps of: rotating the wheel about its axis; detecting and outputting a surface elevation profile of a concentric ring at each of a set of different radial positions on the surface of the wheel; calculating a radial profile of the wheel based on the surface elevation profiles of at least some of the concentric rings; controlling the position of a cutting tool with respect to the wheel to recut the surface of the wheel in accordance with the generated radial profile.

Following the cutting operation, a step of applying a lacquer finish to the recut surface may be provided.

Various further aspects and features of the present invention are shown and described herein.

### BRIEF DESCRIPTION OF THE DRAWINGS

Exemplary embodiments of the present invention will now be described with reference to the following drawings, in which like reference numerals are used to denote like parts, and in which:

FIGS. 1A and 1B schematically illustrate a wheel refinishing apparatus according to an embodiment of the invention;

FIG. 2 schematically illustrates a 3D representation of a wheel images by the apparatus of FIG. 1;

FIG. 3 is a schematic flow diagram of the operation of the wheel refinishing apparatus of FIG. 1; and

FIG. 4 is a schematic flow diagram showing a variable increment radial sampling routine.

### DETAILED DESCRIPTION

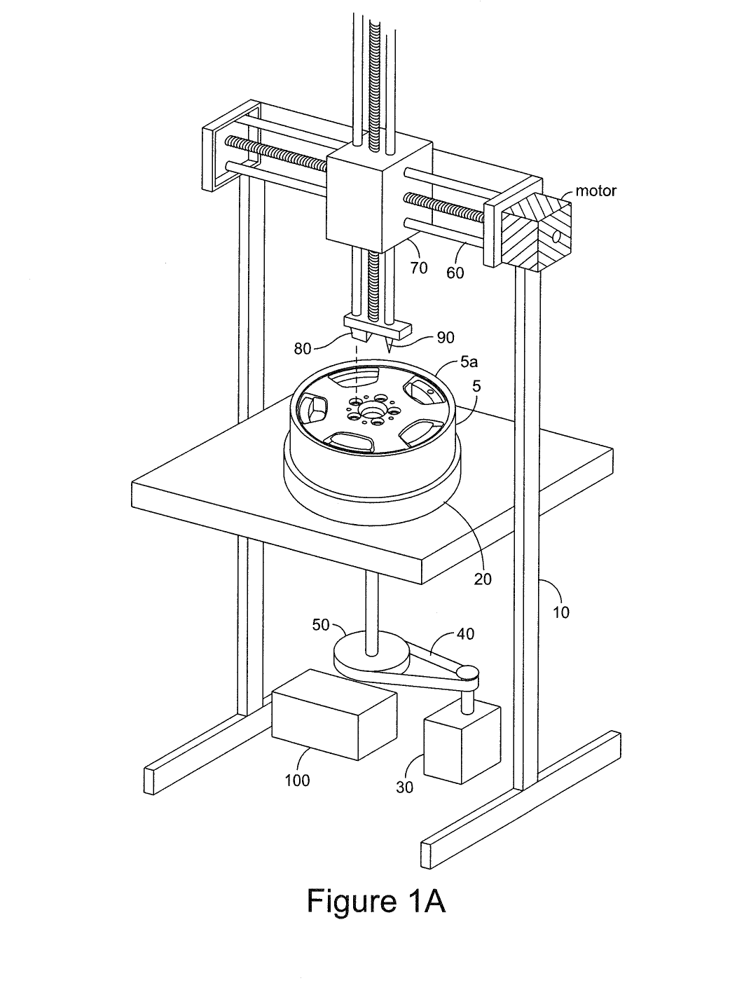

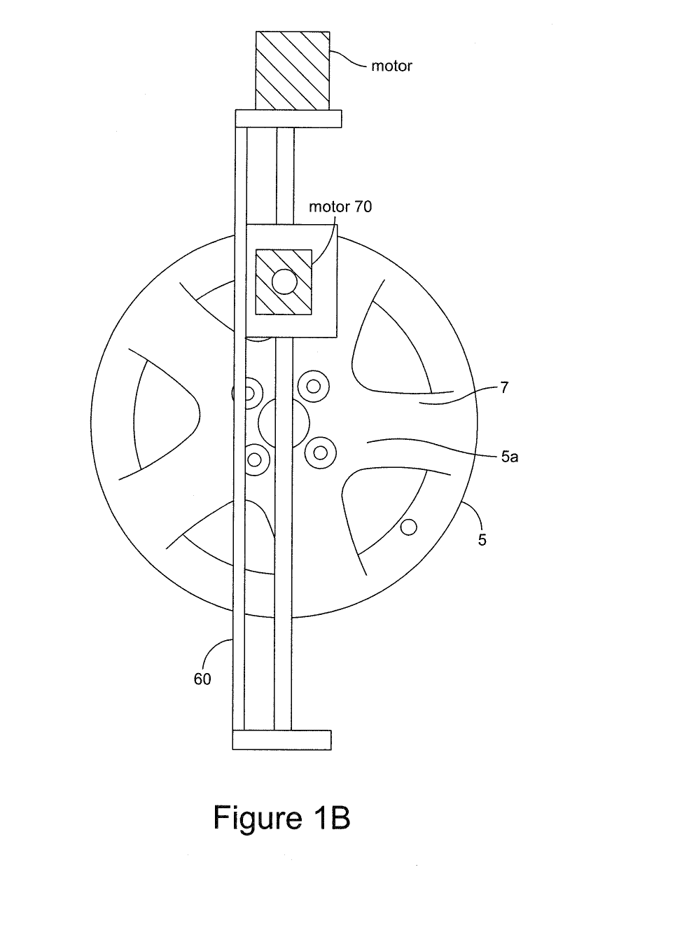

Referring first to FIG. 1A, a side view of a recutting apparatus for a wheel is schematically illustrated. The apparatus comprises a frame 10 which supports a rotating mount 20. The rotating mount 20 receives a wheel 5, and can be driven to rotate by a motor 30 which drives the rotating mount 20 via a belt 40. The motor 20 is driven by a controller 100. The rotational position of the mount 20 (and by inference the angular position of the wheel 5) is detected by an angular encoder 50, which outputs the rotational position to the controller 100. A horizontal linear positioner 60 and a vertical linear positioner 70 are also shown. These position a laser displacement sensor 80 and a cutting tool 90 with respect to the wheel 5. The horizontal linear positioner 60 and the vertical linear positioner 70 are controlled by the controller 100. The laser displacement sensor measures an elevation of the surface 5a of the wheel 5, and is controlled by, and passes data to, the controller 100.

The recutting apparatus effectively operates in a scan mode to map the surface 5a of the wheel 5 and generate a cutting profile for the wheel, and in a cutting mode, in which the surface 5a of the wheel 5 is recut based on a cutting profile generated in the scan mode. In the scan mode, the mount 20 (and thus the wheel 5) is rotated under the control of the controller 100, and the horizontal linear positioner 60 is controlled to position the laser displacement sensor 80 at a desired radial distance from the centre of the wheel 5. During the scan mode the vertical linear positioner 70 is locked into a fixed position. The wheel 5 is rotated about 360 degrees (360°) while the laser displacement sensor 80 measures the surface elevation at the current radial position to form a surface elevation profile for a concentric ring at the desired radial distance. Once a surface elevation profile for a given radius has been completed, the horizontal linear positioner 60 is controlled to position the laser displacement sensor 80 at a different radial distance from the centre of the wheel 5. Again, the wheel 5 is rotated about 360° while the laser displacement sensor 80 measures the surface elevation at the new radial position to form a surface elevation profile for a concentric ring at the new radial distance. This process continues until the complete surface 5a of the wheel 5 has been mapped. In order to generate the 3D map, the controller 100 receives (at a given instant of scanning) an elevation measurement from the laser displacement sensor 80, and a rotational position of the wheel 5 (with respect to a reference position) from the angular encoder 50. The controller 100 is also aware of the radial distance of the laser displacement sensor 80 (either by virtue of its role controlling the horizontal linear positioner 60 or by way of a radial position detector (not shown)). These three elements of information are sufficient to construct a 3D (relief) representation of the surface of the wheel. The elevation data measured at each radial distance is used to form a cutting profile. The cutting profile may be modified by subtracting a desired cutting depth from the radial profile. The cutting depth may be user selected based on operator preference or based on an amount of material required to be removed to obliviate signs of damage. Abnormalities in one or both of the 3D representation and the radial profile can be either automatically detected by the controller 100 and drawn to the attention of the operator, or spotted by the operator prior to the cutting mode being engaged. Each of the 3D representation, the cutting profile and any automatically detected abnormalities can be presented to the operator on a display device (not shown).

It will be understood that the principal component of the surface elevation profile data which is of interest for forming a cutting profile is that which describes the substantially planar top surface of the wheel, including the top surface of the spokes. In order to determine an appropriate elevation value for a given radial position from the surface elevation profile, the following steps are conducted:
(A) A maximum elevation for the radial position is determined;
(B) Elevation data greater than a predetermined distance lower than the maximum elevation is masked (ignored);
(C) An average elevation for the remaining data is determined;
(D) Elevation data outside the central 50% of data points is masked (to remove data relating to spoke edges and other structures); and
(E) An average value (mean, mode or median) is determined from the remaining (unmasked) data.

It will be appreciated that the above is merely one technique for determining an appropriate elevation value for each radial position.

In the cutting mode, the cutting tool 90 is lowered to a desired cutting position by the vertical linear positioner 70 based on the cutting profile. It will be appreciated that the cutting profile could be smoothed (for example using a low pass filter), and that the number (and separation) of radial positions at which cutting takes place may be different to (larger or smaller) than the number (and separation) or radial positions at which surface sampling takes place.

Referring now to FIG. 1B, a top plan view of the apparatus shown in FIG. 1A is schematically illustrated. Clearly visible in FIG. 1B is the top surface 5a of the wheel 5, including spokes 7. Also visible are the horizontal linear positioner 60 and the vertical linear positioner 70, which serve to position the laser displacement sensor 80 and the cutting tool 90 at a desired radial and vertical position.

In summary of the above, it will be understood that, with the laser displacement sensor at a fixed radial distance, the system rotates the wheel slowly whilst taking distance measurements from the sensor. When 360 degrees of distance and angular data has been acquired, the system moves the displacement sensor mounted on a linear stage a small distance along the radial and repeats the data acquisition. Data is collected and modeled using a computer or other data processing apparatus.

By using the depth data coupled with an angular encoder and linear positioning stage position, a 3 dimensional model can be generated within the computer. From this 3 dimensional mapping, a wheel radial profile can be extracted and then used as directions to move a cutting tool along the same (or derived) profile.

It is further understood that the controller may be implemented using one or more corresponding computer processors (e.g. CPU) and associated data storage devices (e.g. memory). The data storage device(s) may store, for example, (i) a program (e.g., computer program code and/or a computer program product) adapted to or configured to direct the processor to perform the functions described herein in accordance with embodiments of the present invention, and (ii) a database adapted to store information that may be utilized or required by the program. One or more computer programs may be stored, for example, in a compressed, an uncompiled and/or an encrypted format, and may include computer program code. The instructions of the program may be read into a main memory of the processor from a non-transitory computer-readable medium other than the data storage device, such as from a ROM or from a RAM. While execution of sequences of instructions in the program causes the processor to perform the process steps described herein, hard-wired circuitry may be used in place of, or in combination with, software instructions for implementation of the processes of embodiments of the present invention. Thus, embodiments of the present invention are not limited to any specific combination of hardware and software. The computer program code required to implement the functions described herein can be developed by a person of ordinary skill in the art, and is not described in detail herein. The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, other memory chip or cartridge, or other medium from which a computer can read. The process steps for carrying out the recutting of the surface of the wheel as described herein may be automatically performed according to the computer executing program instructions.

Various forms of computer readable media may be involved in carrying one or more sequences of one or more instructions to a processor (or any other processor of a device described herein) for execution. For example, a remote computer can load instructions into dynamic memory and send the instructions over an a connection (e.g. Ethernet), cable line, or even telephone line using a modem. A communications device local to a computing device (or, e.g., a server) can receive the data on the respective communications line and place the data on a system bus for the control processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, and the like).

In one example, a scan rate of 3 kHz, a laser spot size of 30 μm and a wavelength of 650 nm are used for the laser displacement sensor and a rotation rate of 0.5 Hz is used for rotating the wheel. It will be appreciated that the overall mapping rate which can be achieved in this way is likely to be superior to that of a touch probe having an approximate dimension of 1 mm and limitations on its speed of safe operation. It will be appreciated that other laser profiling and rotation characteristics could also be used.

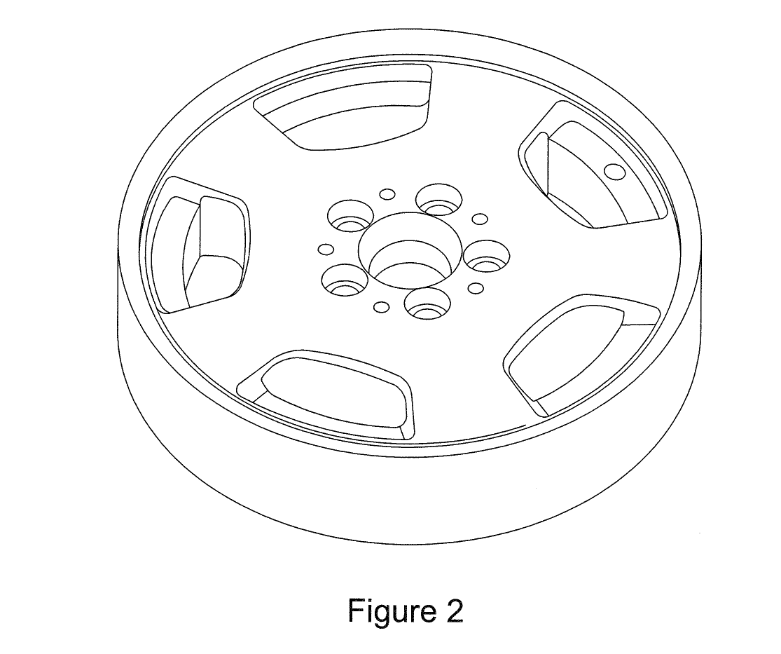

Referring now to FIG. 2, an example 3D representation of a wheel as generated by the scanning mode of the apparatus of FIG. 1 is shown.

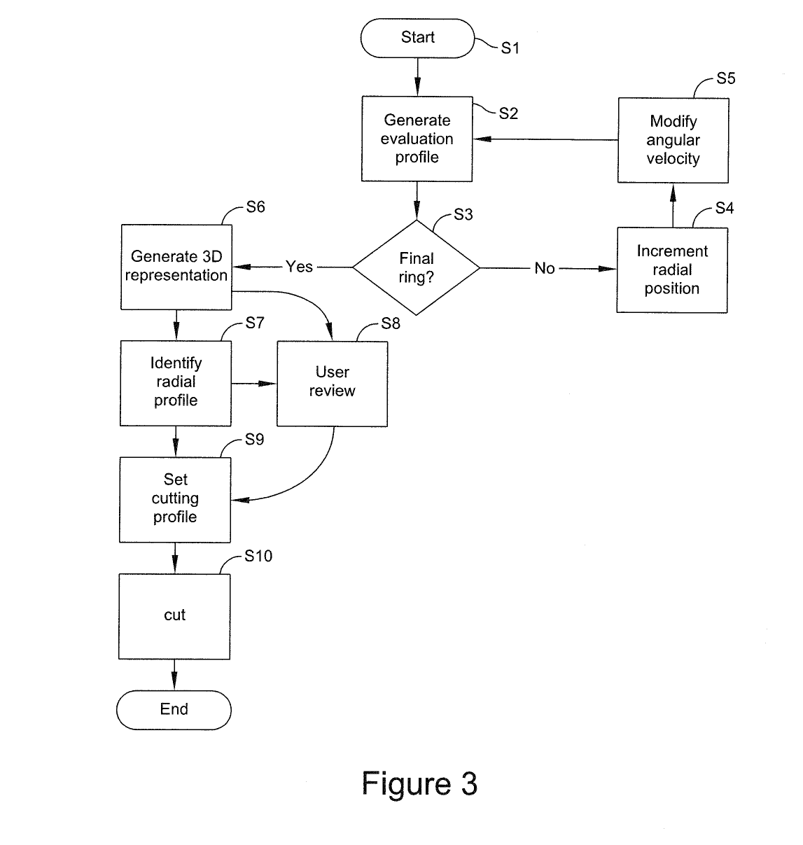

Referring to FIG. 3, a schematic flow diagram is provided which illustrates the scanning and cutting process. The system is initialized at a step S1. This includes setting the horizontal linear positioner 60 and vertical linear positioner 70 to a starting position for scanning. This involves setting the horizontal linear positioner 60 to position the laser displacement sensor 80 to a starting position either at or near the centre of the wheel 5 (if the laser displacement sensor 80 is to be moved incrementally outwards) or at the outer circumference of the wheel 5 (if the laser displacement sensor 80 is to be moved incrementally inwards). The vertical linear positioner 70 will be locked into a fixed position for the duration of the scan mode.

At a step S2, a first elevation profile is generated for a first radial position by rotating the wheel 5 360° on the mount 20 while sampling the elevation measurement generated by the laser displacement sensor 80. At a step S3 it is determined whether the generated elevation profile corresponds to the final concentric ring to be sampled (which of course it will not for the first elevation profile). If it is determined that the generated elevation profile does not correspond to the final concentric ring to be sampled, then the radial position of the laser displacement sensor 80 is incremented at a step S4. Optionally, at a step S5 the angular velocity of the rotation of the wheel 5 may be modified if it is desired to preserve a substantially constant spatial resolution across the surface of the wheel. This could be achieved by providing a slower angular velocity towards the outside of the wheel than towards the centre of the wheel. Otherwise, the step S5 can be omitted and an appropriate fixed angular velocity can be used which will provide a satisfactory level of resolution at the outside of the wheel (at the expense of oversampling towards the centre of the wheel). The process can then return to the step S2, where a further elevation profile is generated at the new radial position. The steps S2 to S4/S5 continue until it is determined at an instance of the step S3 that the final concentric ring has been sampled. The process then moves on to a step S6, where a 3D representation of the surface 5a of the wheel 5 is generated and displayed.

A radial profile corresponding to the elevation data at each radial position is also generated at a step S7, either directly from the raw data or indirectly from the 3D representation. The 3D representation and the radial profile are then provided to the operator for user review at a step S8. The 3D representation may include highlighted “problem” regions automatically detected by a computer. These may relate to damage to the wheel which might prejudice vehicle safety (giving the recutting technique a secondary benefit as a safety diagnostic tool) or might cause problems for recutting. Also at the step S8 the user is able to set a cutting depth (how much material is to be removed from the surface of the wheel). At a step S9, the selected cutting depth is applied to the radial profile to set a cutting profile. The step S9 also receives operator approval for the cutting mode to be engaged, leading to recutting taking place at a step S10. The recutting process causes the cutting tool 90 to be moved with respect to the (rotating) wheel to follow the cutting profile set at the step S9. The recutting process is completed when the cutting tool 90 has been applied throughout at least one complete rotation of the wheel for each radial position at which cutting is to take place.

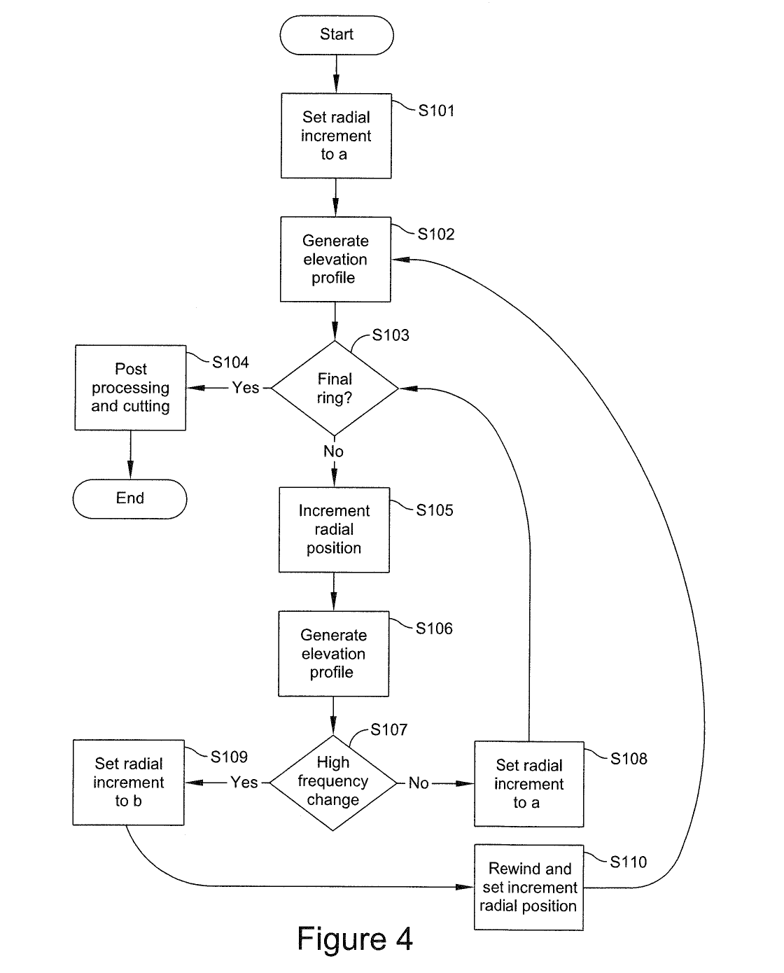

Referring now to FIG. 4, a schematic flow diagram is provided which explains how fine surface detail can be sampled at a different radial resolution than coarse surface detail. At a step S101, the radial increment which separates the concentric circles to be scanned is set to a first value, a. Then, at a step S102, an elevation profile is generated for a current radial position. At a step S103, it is determined whether the current concentric ring is the final one to be sampled. If it is the final ring then at a step S104 the steps S6 to S10 described in FIG. 3 are conducted. If it is not the final ring then the radial position of the laser displacement sensor 80 is incremented by the first value a at a step S105, and a further elevation profile is generated at the step S106. At a step S107 it is determined whether there has been a high frequency change between adjacent elevation profiles. This could be determined where the magnitude of a change in elevation between adjacent concentric circles exceeds a predetermined threshold. If there has not been a high frequency change then the radial increment is set (or retained) at the value a at a step S108 whereupon the process returns to the step S103. The steps S103 to S107 are then repeated. If at the step S107 it is determined that there has been a high frequency change between adjacent elevation profiles then the radial increment is set to a second value b and the position of the laser displacement sensor 80 is “rewound” back to the previous radial position and then incremented by the value b (which is less than the value a) at a step S110. The process then returns to the step S102. It will be appreciated that the process (steps S103 to S110) will continue using the increment value b until the step S107 determines a low frequency change between adjacent elevation profiles. This could be determined where the magnitude of a change in elevation between adjacent concentric circles falls below a predetermined threshold. It should be understood that the respective thresholds for detecting high frequency and low frequency changes may be different. By way of the above process it is possible to sample (in the radial direction) planar areas at a relatively coarse level and edged and detail areas at a relatively fine level. As an example, a radial step size of 2 mm could be used for coarse detail and a step size of 0.1 mm could be used for fine detail. It will be appreciated that other step sizes could also be used.

While the foregoing invention has been described with reference to the above embodiments, various modifications and changes can be made without departing from the spirit of the invention. Accordingly, all such modifications and changes are considered to be within the scope of the appended claims.

What is claimed is:

1. An apparatus for recutting the surface of a wheel, the apparatus comprising:
a rotatable mount for holding and rotating the wheel about its axis;
a surface profiler configured to detect and output a surface elevation profile of a concentric ring at a current radial position on the surface of the wheel;
a linear drive mechanism configured to reposition the surface profiler radially with respect to the wheel,
a cutting profile generator configured to calculate a cutting profile for the wheel based on the surface elevation profiles of at least some of the concentric rings; and
cutting control circuitry configured to control the position of a cutting tool with respect to the wheel to recut the surface of the wheel in accordance with the generated cutting profile.

2. An apparatus according to claim 1, further comprising a cutting tool moveable both radially with respect to the wheel and parallel to the axis of rotation of the wheel, and wherein the cutting control circuitry is configured to control the position of the cutting tool and the rotation of the wheel to recut the surface of the wheel.

3. An apparatus according to claim 2, wherein the cutting tool and the surface profiler are co-mounted, and wherein the cutting control circuitry is configured to control the axial position of the cutting tool using the linear drive mechanism.

4. An apparatus according to claim 1, further comprising:
a 3D map generator, configured to generate and display to an operator a 3D representation of the surface of the wheel based on a set of surface elevation profiles of concentric rings at different radial positions.

5. An apparatus according to claim 4, further comprising:
an angular encoder, configured to detect and output a current angular position of the wheel with respect to a reference position,
wherein the 3D map generator generates the 3D representation using the current angular positions output by the angular encoder.

6. An apparatus according to claim 5, wherein the 3D map generator is configured to detect abnormalities in the surface of the wheel from the 3D representation, and to highlight any detected abnormalities to the operator.

7. An apparatus according to claim 1, wherein the surface profiler is a non-contact profiler.

8. An apparatus according to claim 7, wherein the non-contact profiler is an optical device.

9. An apparatus according to claim 8, wherein the optical device is a laser.

10. An apparatus according to claim 1, wherein the rotatable mount is configured to rotate the wheel at a constant angular velocity for all radii.

11. An apparatus according to claim 10, wherein the constant angular velocity is selected in dependence on the maximum radius for surface elevation measurement and the sampling rate of the surface profiler.

12. An apparatus according to claim 1, wherein the rotatable mount is configured to rotate the wheel at a variable angular velocity, the angular velocity being decreased incrementally as the linear drive mechanism increases the radial distance of the surface profiler from the centre of the wheel.

13. An apparatus according to claim 1, wherein the linear drive mechanism is configured:
a. to incrementally reposition the surface profiler by a first radial distance following the completion of a surface elevation profile of each concentric ring;
b. to incrementally reposition the surface profiler by a second radial distance smaller than the first radial distance at, near or around a radius at which a high frequency change between the surface elevation profiles of adjacent concentric rings occurs.

14. An apparatus according to claim 13, wherein the linear drive mechanism is configured:
c. to detect a high frequency change when the change in surface elevation on a radial line between a first surface elevation profile and a second surface elevation profile exceeds a first predetermined magnitude;
d. to rewind the surface profiler position and incrementally reposition the surface profiler by the second radial distance from the radial position corresponding to the first surface elevation profile;
e. to continue to incrementally reposition the surface profiler by the second amount until a change in the surface elevation between adjacent surface elevation profiles falls below a second predetermined magnitude, whereupon the linear drive mechanism reverts to incrementally repositioning the surface profiler by the first amount.

15. A method of recutting the surface of a wheel, the method comprising the steps of:
rotating the wheel about its axis;
detecting and outputting a surface elevation profile of a concentric ring at each of a set of different radial positions on the surface of the wheel;
calculating a cutting profile for the wheel based on the surface elevation profiles of at least some of the concentric rings;
controlling the position of a cutting tool with respect to the wheel to recut the surface of the wheel in accordance with the generated cutting profile.

16. A method according to claim 15, further comprising:
generating and displaying to an operator a 3D representation of the surface of the wheel based on a set of surface elevation profiles of concentric rings at different radial positions.

17. A method according to claim 16, further comprising:
detecting abnormalities in the surface of the wheel from the 3D representation, and highlighting any detected abnormalities to the operator.

18. A method according to claim 15, wherein the surface elevation profile is generated by a laser.

19. A method according to claim 18, wherein the wheel is rotated at a constant angular velocity for all radii.

20. A method according to claim 19, wherein the constant angular velocity is selected in dependence on the maximum radius for surface elevation measurement and the sampling rate used to generate the surface elevation profile.

21. A method according to claim 15, wherein the rotatable wheel is rotated at a variable angular velocity, the angular velocity being decreased incrementally for concentric rings further from the centre of the wheel.

22. A method according to claim 15, further comprising
a. incrementally repositioning a surface profiler by a first radial distance following the completion of a surface elevation profile of each concentric ring;
b. detecting a high frequency change between the surface elevation profiles of adjacent concentric rings, and if such a change is detected, to incrementally reposition the surface profiler by a second radial distance smaller than the first radial distance at, near or around the radius at which the high frequency change was detected.

23. A method according to claim 22, further comprising:
c. detecting a high frequency change when the change in surface elevation on a radial line between a first surface elevation profile and a second surface elevation profile exceeds a first predetermined magnitude;
d. to rewind the surface profiler position and incrementally reposition the surface profiler by the second radial distance from the radial position corresponding to the first surface elevation profile;
e. to continue to incrementally reposition the surface profiler by the second amount until a change in the surface elevation between adjacent surface elevation profiles falls below a second predetermined magnitude, and then reverting to incrementally repositioning the surface profiler by the first amount.

24. A method according to claim 15, further comprising a step of applying a lacquer finish to the recut surface.
